(19) United States
(12) Patent Application Publication
(10) Pub. No.: US 2010/0257403 A1
(43) Pub. Date: Oct. 7, 2010

(54) RESTORATION OF A SYSTEM FROM A SET OF FULL AND PARTIAL DELTA SYSTEM SNAPSHOTS ACROSS A DISTRIBUTED SYSTEM

(75) Inventors: Navjot Virk, Bellevue, WA (US); Elissa E. Murphy, Seattle, WA (US); John D. Mehr, Kenmore, WA (US); Yan V. Leshinsky, Bellevue, WA (US); Lara M. Sosnosky, Kirkland, WA (US); James R. Hamilton, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/418,315

(22) Filed: Apr. 3, 2009

(51) Int. Cl. G06F 11/07; G06F 17/30

(52) U.S. Cl. 714/15; 707/E17.108; 714/E11.023

(57) ABSTRACT

Provided herein are systems and methodologies for highly efficient backup and restoration in a network-based backup system. A distributed, hybrid peer-to-peer (P2P)/cloud backup architecture is leveraged, wherein information can be segmented and distributed across a set of peers and one or more global storage locations (e.g., cloud storage locations) within an associated network or internetwork. Using this architecture, images and/or delta blocks corresponding to respective images are intelligently placed across storage locations based on various network factors such as node locality, health, capacity, or the like. Similarly, restoration of a system can be performed by querying respective locations at which data corresponding to a desired system state are located and pulling the data from one or more optimal network locations as listed in an index and/or a similar structure based on similar network factors.

### BACKGROUND

As computing devices become more prevalent and widely used among the general population, the amount of data generated and utilized by such devices has rapidly increased. For example, recent advancements in computing and data storage technology have enabled even the most limited form-factor devices to store and process large amounts of information for a variety of data-hungry applications such as document editing, media processing, and the like. Further, recent advancements in communication technology can enable computing devices to communicate data at a high rate of speed. These advancements have led to, among other technologies, the implementation of distributed computing services that can, for example, be conducted using computing devices at multiple locations on a network. In addition, such advancements have enabled the implementation of services such as network-based backup, which allow a user of a computing device to maintain one or more backup copies of data associated with the computing device at a remote location on a network.

Traditionally, network-based or online backup solutions enable a user to store backup information in a location physically remote from its original source. However, in such an implementation, costs and complexity associated with transmission and restoration of user data between a user machine and a remote storage location can substantially limit the usefulness of a backup system. For example, in a scenario in which a backup or restore of an operating system (OS) image or a system snapshot is desired, existing backup solutions generally require a sizeable amount of information to be communicated between a backup client and an associated backup storage location. Due to the amount of information involved, such communications can be computationally expensive at both the client and network side and/or can lead to significant consumption of expensive bandwidth, in view of the foregoing, it would be desirable to implement network-based backup techniques with improved efficiency.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Systems and methodologies are provided herein that facilitate highly efficient backup and restoration techniques for network-based backup systems. A distributed storage scheme can be utilized, such that OS images, system snapshots, and/or other large images or files can be segmented and distributed across multiple storage locations in an associated backup system. In accordance with one aspect, hybrid peer-to-peer (P2P) and cloud backup architecture can be utilized, wherein information corresponding to images or files and/or delta blocks corresponding to incremental changes to images or files can be layered across a set of peers or super-peers and one or more global storage locations (e.g., cloud storage locations) within an associated network or internetwork. Accordingly, a backup client can obtain some or all information necessary for carrying out a restore from either the cloud or one or more nearby peers or super-peers, thereby reducing latency and required bandwidth consumption.

In accordance with another aspect, images or files and/or delta blocks corresponding to respective images or files can be intelligently placed across storage locations in a distributed backup system based on factors such as peer and cloud availability, network health, network node location, network node capacity, network topology and/or changes thereto, peer type, or the like. Similarly, restoration can be performed by pulling data from one or more optimal locations in the distributed system based on similar factors. In one example, one or more statistical learning techniques can be utilized to increase the efficiency and effectiveness of the distribution and/or restoration processes.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a high-level block diagram of a system for restoring information from a backup system in accordance with various aspects.

FIG. 2 is a block diagram of a system for generating backup information in accordance with various aspects.

FIG. 3 is a block diagram of a system for indexing and distributing information in a distributed backup system in accordance with various aspects.

FIG. 4 is a block diagram of a system for performing system restoration using data located within a hybrid cloud-based and peer-to-peer backup system in accordance with various aspects.

FIG. 5 is a block diagram of a system that facilitates intelligent storage and retrieval of information within a distributed computing system in accordance with various aspects.

FIG. 6 illustrates an example network implementation that can be utilized in connection with various aspects described herein.

FIG. 7 is a flowchart of a method for restoring a system using a distributed backup network.

FIG. 8 is a flowchart of a method for distributing data to respective locations in a network-based backup system.

FIG. 9 is a flowchart of a method for identifying, retrieving, and restoring data in a network-based backup environment.

FIG. 10 is a block diagram of a computing system in which various aspects described herein can function.

FIG. 11 illustrates a schematic block diagram of an example networked computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” “interface,” “schema,” “algorithm,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

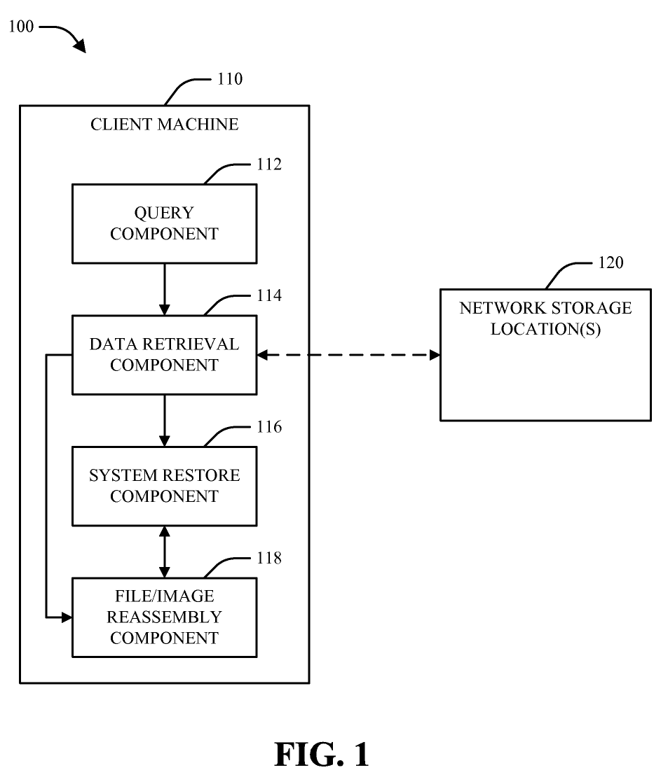

Referring now to the drawings, FIG. 1 illustrates a block diagram of a system 100 for restoring information from a backup system in accordance with various aspects described herein. As system 100 illustrates, restoration can be performed on a client machine 110 by leveraging one or more network-based backup techniques detailed herein, in which associated system information and/or other data can be located at one or more network data stores 120. As described herein, client machine 110 can be any suitable computing device such as, for example, a personal computer (PC), a notebook or tablet computer, a personal digital assistant (PDA), a smartphone, or the like. Further, network data store(s) 120 can be associated with any suitable number of computing devices located in a network and/or internetwork associated with client machine 110.

In one example, system 100 can be utilized to restore files, system images, and/or other data using information from a current version residing on a client machine 110 to a desired version residing at network data store(s) 120. Additionally or alternatively, a full restore of information can be conducted at client machine 110 from information stored at network data store(s) 120 in the event of data loss (e.g., due to disk corruption, inadvertent deletion or formatting, etc.) or a similar event. In accordance with one aspect, system 100 can be utilized in connection with a network-based or online backup solution (e.g., a cloud backup system, as described in further detail infra) that stores backup information from client machine 110 via the network data store(s) 120.

In accordance with one aspect, system 100 can be utilized to restore an OS image, system snapshot, and/or other information relating to an operating environment of client machine 110. Conventionally, network-based and other backup solutions operate by backing up files and/or system images associated with a user machine at various points in time, such as at regular, periodic intervals and/or upon modification of respective files. These files are subsequently stored in their entirety at one or more locations, such as on a hard drive at the user machine, a removable storage medium (e.g., CD, DVD, etc.), and/or network storage locations. However, in the specific example of network-based backup storage, it can be appreciated that backup of an OS in a state associated with a system and/or a snapshot of some or all items associated with a system can result in frequent transmissions of large amounts of information across the backup system. Thus, it can be appreciated that the ability to restore a system in a conventional network-based backup system is limited by the overall size and frequency of generated images.

Accordingly, system 100 can mitigate the above noted shortcomings and provide optimized imaging for a backup system by leveraging a distributed system of network storage locations 120. More particularly, information corresponding to an OS image, a system snapshot, and/or other information can be segmented and/or otherwise configured to be distributable and retrievable across a set of multiple network storage locations 120 as block level data corresponding to the information and/or incremental changes to the information, thereby substantially reducing latency and bandwidth requirements associated with network-based backup as described herein.

In accordance with one aspect, operation of client machine 110 in system 100 can proceed as follows. Initially, information to be backed up at client machine 110 can be segmented and/or otherwise distributed among a set of multiple network storage locations 120. In one example, single instancing, de-duplication, and/or other suitable techniques can be applied to enable partial information (e.g. representing incremental changes to already stored information) to be distributed rather than the corresponding full information. Techniques by which such distribution of backup data can be performed are provided in further detail infra.

Subsequently, upon determining that a system restore is desired at client machine 110, a query component 112 at client machine 110 can query respective network storage locations 120 for copies of various images and/or incremental images corresponding to client machine 110. In one example, when a restoration or rebuild occurs, query component 110 can query multiple network storage locations 120 for respective blocks or segments corresponding to a restore, such that client machine 110 can retrieve the blocks or segments by pulling portions of the desired information from multiple network storage locations 120.

In another example, blocks or segments corresponding to respective information can be single instanced and/or otherwise de-duplicated across client machine 110 and network storage location(s) 120 such that client machine 110 can rebuild information by obtaining less than all information corresponding to the information to be rebuilt. For example, network data store(s) 120 can contain respective images and/or a series of incremental images that correspond to respective states or versions of client machine 110 over time, and query component 112 can facilitate recovery of client machine 110 to a selected version and/or corresponding point in time by identifying for retrieval only blocks of images or incremental images that are not locally stored by client machine. Locally stored blocks at client machine 110 can correspond to, for example, blocks distributed during the backup process and/or blocks corresponding to a current version or operational state of client machine 110 (e.g. thereby allowing restoration to be conducted by merging respective received blocks with a current version of client machine 110). Additionally or alternatively, query component 112 can facilitate retrieval of blocks relating to recovery of client machine 110 to a default state, which can correspond to, for example, the state of client machine 110 at its creation, at the time of installation of a given OS, and/or any other suitable time.

In accordance with one aspect, upon identification of desired blocks and/or their respective locations within network storage locations 120 by query component 112, a data retrieval component 114 can be utilized by client machine 110 to obtain the respective blocks from one or more of their identified locations. In one example, data retrieval component 114 can be configured to obtain respective information from an optimal “path of least resistance” through network storage locations 120. For example, network storage locations 120 can correspond to a hybrid P2P/cloud backup architecture, wherein one or more network storage locations 120 correspond to respective designated cloud servers on the Internet and one or more other network storage locations 120 correspond to respective local peer or super-peer machines. Accordingly, data retrieval component 114 can pull at least a portion of requested information from one or more local peers, thereby reducing the latency and/or bandwidth requirements associated with obtaining information from the Internet. By way of specific example, data retrieval component 114 can determine that a given block is located both at a cloud storage location on the Internet and at one or more peer machines associated with a local network. In such an example, data retrieval component 114 can facilitate retrieval of the block from the nearest available peer to facilitate faster retrieval and conserve network bandwidth, falling back to the cloud only if no peers are available. Examples of implementations that can be utilized for a peer-to-peer and/or cloud based storage architecture are provided in further detail infra.

In another example, a map, index, and/or other metadata relating to respective blocks stored by system 100 and their respectively corresponding network storage locations 120 can be maintained by client machine 110 and/or network storage location(s) 120. Accordingly, query component 112 and/or data retrieval component 114 can be configured to look up locations of respective information using the index. Additionally or alternatively, data retrieval component 114 can be configured to determine optimal locations of respective blocks or segments of information using network analysis techniques based on factors such as location, health, network topology, peer type (e.g. peer or super-peer), storage location availability, or the like. In one example, such techniques can be performed with or without the aid of statistical learning algorithms and/or other artificial intelligence (AI), machine learning, or automation tools. Techniques for performing this network analysis are provided in further detail infra.

Once data retrieval component 114 has obtained information identified by query component 112 in connection with a restore operation from network storage location(s), a system restore component 116 at client machine 110 can utilize the obtained information to rebuild the operational state of client machine 110. In one example, rebuilding performed by system restore component 116 can correspond to a full system restore (e.g., in the case of hard disk failure, inadvertent deletions and/or disk formatting, or the like), a rollback to a previous known-good or otherwise desired state, and/or any other suitable type of restoration. In one example, system restore component 116, either operating individually or with the aid of a file/image reassembly component 118, can restore an OS, system snapshot, one or more files, or the like at client machine 110 using a reverse difference algorithm, in which changes in a current version over a desired version are rolled back using respective file segments or blocks that correspond to differences and/or changes between the current version and the desired version. It should be appreciated, however, that system and/or file restoration can be performed as described herein using any suitable algorithm.

In one example, query component 112, data retrieval component 114, system restore component 116, and/or file/image reassembly component 118 can utilize one or more authentication measures to provide a secure connection to network storage location(s) 120 for rebuilding client machine 110. For example, prior to or during a query performed by 112 and/or a transfer request performed by data retrieval component 114, a user of client machine 110 can authenticate and sign on to one or more network storage locations 120 to complete said operation(s).

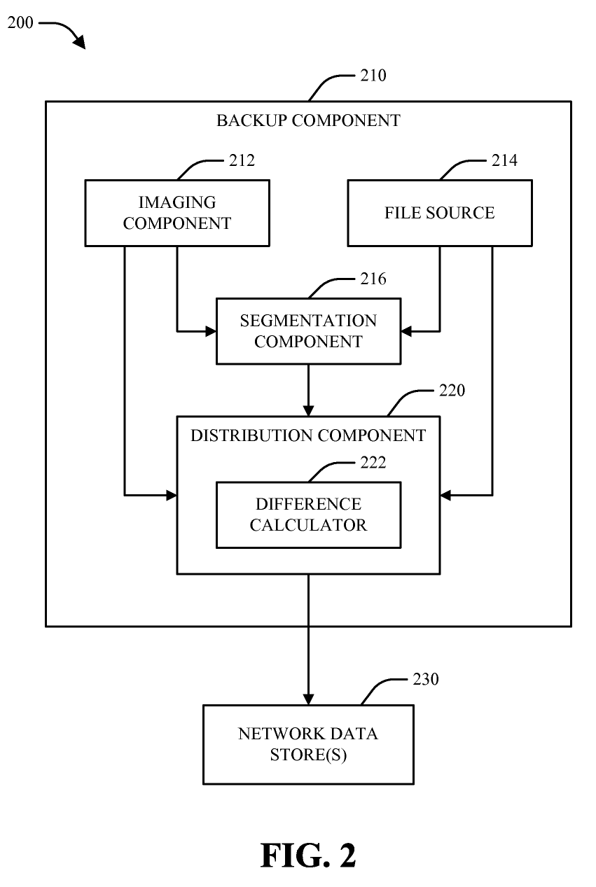

Turning now to FIG. 2, a system 200 for generating backup information in accordance with various aspects is illustrated. As FIG. 2 illustrates, system 200 can include a backup component 210, which can generate and facilitate storage of backup copies of files, system snapshots, and/or other information associated with a backup client machine. In one example, backup component 210 can reside on and/or operate from a machine on which the client information to be backed up is located. Additionally or alternatively, backup component 210 can reside on a disparate computing device (e.g., as a remotely executed component). In one example, backup component 210 can be utilized to back up a set of files and/or other information at a regular interval in time, upon the triggering of one or more events (e.g., modification of a file), and/or based on any other suitable activating criteria.

In accordance with one aspect, backup component 210 can be utilized to preserve information corresponding to the operational state of an associated machine. Thus, for example, an imaging component 212 can be utilized to create one or more images of an operating system (OS), memory, disk storage, and/or other component(s) of an associated machine. In one example, system images and/or other information created by imaging component 212 can be provided in an imaging file format, such as Virtual Hard Disk (VHD) format, Windows® Imaging (WIM) format, or the like, and/or any other suitable format. In one example, system images 212 can be provided to a distribution component 220 for transfer to one or more network data stores 230 as described in further detail infra. Similarly, a file source 214 can be utilized to identify one or more files to be provided to distribution component 220.

In accordance with another aspect, system images and/or other information generated by imaging component 212, files provided by file source 214, as well as any other suitable information, can additionally or alternatively be processed by a segmentation component 216. In one example, segmentation component 216 can divide a given file or image into respective sections, thereby allowing backup of the file or image to be conducted in an incremental manner and reducing the amount of bandwidth and/or storage space required for implementing system 200. This can be accomplished by segmentation component 216, for example, by first dividing a file and/or image to be backed up into respective file segments (e.g., blocks, chunks, sections, etc.). In one example, segmentation or chunking of a file or image can be performed by segmentation component 216 in a manner that facilitates de-duplication of respective segments. For example, segmentation component 216 can utilize single instancing and/or other appropriate techniques to identify only unique blocks corresponding to one or more images for distribution via distribution component 220. In one example, upon detection of unique blocks in, for example, an updated version of a file or image, segmentation component 216 can facilitate incremental storage of new and/or changed blocks corresponding to the file or image and/or other information relating to changes between respective versions of the file or image. These updates, referred to generally herein as incremental or delta updates, can also be performed to facilitate storage of information relating to the addition of new blocks, removal of blocks, and/or any other suitable operation and/or modification.

In accordance with an additional aspect, upon generation of blocks or segments by segmentation component 216, various blocks corresponding to respective system images, files, and/or other information can be provided to a distribution component 220 in addition to and/or in place of system images created by imaging component 212 and/or files provided by file source 214. Subsequently, distribution component 220 can distribute the provided information from imaging component 212, file source 214, and/or segmentation component 216 among one or more network data stores 230. Network data stores 230 can be associated with, for example, peer machines in a local network, Internet-based storage locations (e.g., cloud servers), and/or other suitable storage sites. Techniques for distributing information among network storage locations are described in further detail infra.

In one example, imaging component 212 and segmentation component 216 can operate in a coordinated manner to minimize the amount of information provided to distribution component 220. For example, upon performing an initial backup, imaging component 212 can take a snapshot or image of an associated system using one or more snapshotting or imaging algorithms described herein and/or generally known in the art. Such an image can then be provided to segmentation component 216 and/or distribution component 220 as an initial backup. Upon generating a subsequent image or snapshot of the associated system, segmentation component can divide the initial image and the subsequent image into corresponding segments and perform single instancing and/or other de-duplication such that only blocks in the subsequent image that are unique from the initial image are provided to the distribution component 220 and stored across network data stores 230. In one example, such single instancing and/or de-duplication can be performed by a difference calculator 222, which can be associated with distribution component 220 and/or any other suitable entity in system 200.

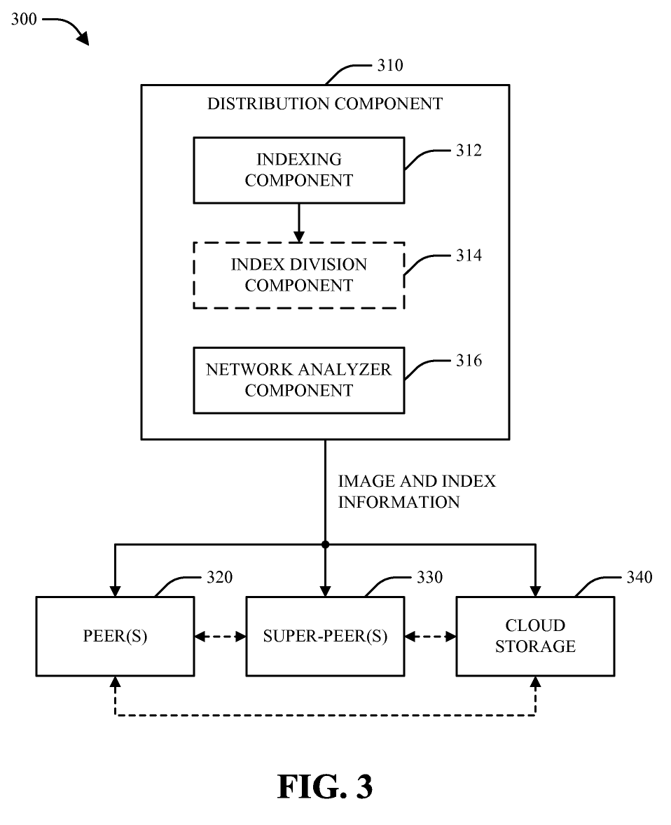

Turning now to FIG. 3, a block diagram of a system 300 for indexing and distributing information in a distributed backup system in accordance with various aspects is illustrated. As FIG. 3 illustrates, system 300 can include a distribution component 310, which can distribute data associated with a client machine among one or more storage locations. In an aspect as illustrated by system 300, a hybrid P2P/cloud-based architecture can be utilized by system 300. By using such an architecture, it can be appreciated that distribution component 310 can distribute information to storage locations such as one or more trusted peers, such as peer(s) 320 and/or super-peer(s) 330, one or more cloud storage locations 340, and/or any other suitable location(s).

As further illustrated in system 300, peer(s) 320, super-peer(s) 330, and/or cloud storage 340 can be further operable to communicate system images, files, and/or other information between each other. In addition, it can be appreciated that distribution component 310 and/or any other components of system 300 could additionally be associated with one or more peers 320, super-peers 330, or entities associated with cloud storage 340. Further detail regarding techniques by which peer(s) 320, super-peer(s) 330, and cloud storage 340 can be utilized, as well as further detail regarding the function of such entities within a hybrid architecture, is provided infra.

In accordance with another aspect, distribution component 310 can include and/or otherwise be associated with an indexing component 312, which can maintain an index and/or other metadata relating to respective mapping relationships between information distributed by distribution component 310 and corresponding locations to which the information has been distributed. In one example, this index can be distributed along with information represented therein to one or more peers 320, super-peers 330, or cloud storage locations 340. It can be appreciated that an entire index can be distributed to one or more locations 320-340, or that an index can additionally or alternatively be divided into segments (e.g., using an optional index division component 314 and/or any other suitable mechanism) and distributed among multiple locations. For example, a complete copy of an associated index can be stored at all locations 320-340. Alternatively, the index could be divided by index division component 314 and portions of the index can be distributed among different locations 320-340. As another alternative, a full index and/or index portions can be selectively distributed among locations 320-340 such that, for example, a first portion of locations 320-340 are given full indexes, a second portion are given index portions, and a third portion are not given index information. Selection of locations 320-340 to be given a full index and/or index portions in such an example can be based on storage capacity, processing power, and/or other properties of respective locations 320-340. Accordingly, in one example, a cloud storage location 340 can be given a full index, while index information can be selectively withheld from a peer location 320 corresponding to a mobile phone and/or another form factor-constrained device. In another example, a given “master” storage location (e.g. cloud storage 340) can be provided with a full index, and other storage locations (e.g. peers 320 and/or super-peers 330) can be provided with only the subsections of the index that are specific to data stored by the respective storage locations.

In accordance with an additional aspect, distribution component 310 can further optionally include a network analyzer component 316, which can analyze a computing network associated with system 300 to determine one or more locations 320-340 to distribute respective information. In one example, network analyzer component 316 can select one or more destinations for information to be distributed based on factors such as network loading, availability and/or health of storage locations (e.g., based on device activity levels, powered-on or powered-off status, available storage space at respective locations, etc.), or the like. In one example, this can be done to balance availability of various data with optimal locality. Techniques for performing network analysis in connection with data distribution are provided in further detail infra.

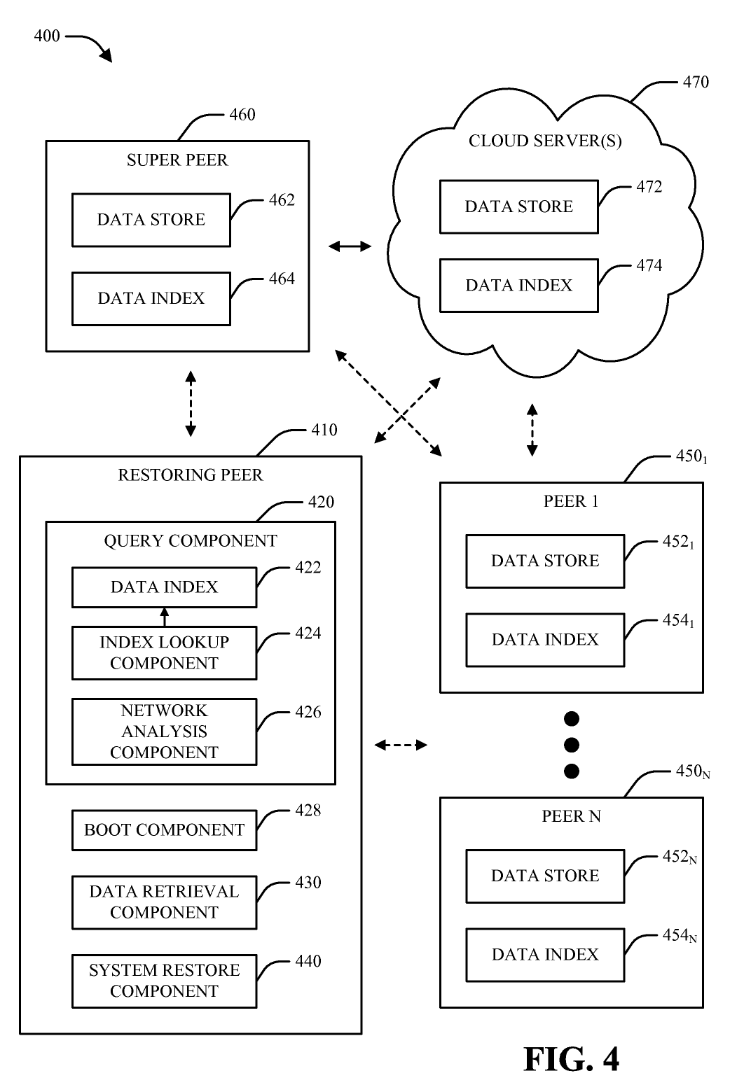

Referring to FIG. 4, a system 400 for performing system restoration using data located within a hybrid cloud-based and peer-to-peer backup system is illustrated. As system 400 illustrates, backup data corresponding to a restoring peer machine 410 can be distributed among respective data stores 452, 462, and/or 472 at one or more peer machines 450, one or more super peer machines 460, and/or one or more cloud storage locations 470. In addition, although not illustrated in system 400, data corresponding to restoring peer 410 can additionally be stored locally at restoring peer 410. In addition to respective data stores 452, 462, and/or 472, respective peers 450, super peers 460, and/or cloud servers 470 can additionally employ respective data indexes 454, 464, and/or 474 (e.g., as created by an indexing component 312 and distributed by a distribution component 310) or data index portions (e.g., as created by an index division component 314) that provide metadata relating to some or all data stored within system 400 and their respective locations within system 400. Additionally and/or alternatively, a data index 422 or a portion thereof can be located at restoring peer 410.

In one example, super peer 460 can be and/or otherwise implement the functionality of a content delivery network (CDN), an enterprise server, a home server, and/or any other suitable pre-designated computing device in system 400. One or more super peers 460 can be chosen, for example, based on their communication and/or computing capability in relation to one or more other devices in system 400 such that devices having a relatively high degree of such capabilities are designated as super peers 460. Additionally or alternatively, super peers 460 can be chosen based on location, availability (e.g., uptime), storage capacity, or the like. Additional detail regarding super peers 460 and their operation within system 400 is provided in further detail infra.

In accordance with one aspect, restoring peer 410 can rebuild system operating information, such as an OS and/or a system snapshot, and/or other appropriate information as follows. Initially, upon identifying that a restore of system information is desired at restoring peer 410, a query component 420 can be utilized to select one or more images and/or delta images or blocks to be obtained for the restore. In one example, query component 420 can determine one or more blocks to be obtained by identifying a system image to be retrieved and/or one or more blocks corresponding to the image. Alternatively, in the case of a rollback restoration or a similar operation where it is desired to rebuild a previous state of restoring peer from a currently available state, query component 420 can perform a differential between the currently available version and the desired version to identify blocks to be obtained.

Following identification of information to be obtained, query component 420 can subsequently query one or more storage locations in system 400 in order to identify locations among peers 450, super peers 460, and/or a cloud server 470 to which requests for data are to be communicated. In accordance with one aspect, query component 420 can utilize an index lookup component 424 to read a full or partial data index 422 stored at restoring peer 410, in addition to or in place of respective full or partial data indexes 454, 464, and/or 474 distributed throughout system 400. It should be appreciated, however, that data indexes 422, 454, 464, and/or 474 and/or index lookup component 424 are not required for implementation of system 400 and that query component 420 can identify locations of information to be retrieved in any suitable manner. For example, as an alternative to index lookup, query component 420 can contain respective hashes of blocks to be retrieved and request all peers 450 and/or 460 and/or cloud server(s) 470 to report back if the blocks exist at the respective locations.

In one example, data index(es) 422, 452, 462, and/or 472 can contain tables, metadata, and/or other information that points to respective blocks identified by query component 420 as needed for a given restore operation. In another example, location(s) of data index(es) utilized by index lookup component 424 can be determined as a function of the capabilities of restoring peer 410 at a given time. Thus, for example, a restoring peer 410 with a relatively large amount of memory and processing power can have a full data index 422, while a restoring peer with less memory and/or processing power can have a partial data index or no data index. In accordance with one aspect, the event that a local data index 422 is not present or is unavailable (e.g., due to a system failure), query component 420 can be equipped with mechanisms by which a data index 454 at a neighboring peer 450, a data index 464 at a super peer 460, and/or a data index 474 at a cloud server 470 can be utilized in place of a local data index 422.

In accordance with one aspect, restoring peer 410 can additionally contain a boot component 428, which can facilitate a network boot of restoring peer 410 from one or more remote locations in system 400. Thus, in one example, in the event that restoring peer 410 is unable to boot using locally available information (e.g., due to a system failure), boot component 428 can be triggered to boot restoring peer 410 from an external entity in order to initiate system restoration using any suitable techniques. For example, a network boot can be performed as a Preboot Execution Environment (PXE) boot and/or a similar type of network boot, initiated using a physical restoration disk, and/or initialized in any other suitable manner.

In accordance with another aspect, query component 420 can utilize a network analysis component 426, which can analyze system 400 to enable restoring peer 400 to obtain information from the path of least resistance through system 400. Thus, for example, in the event that a given image or image portion resides at a peer 450 or super peer 460 as well as at a cloud server 470, preference can be given to pulling the block from the nearest network nodes first to minimize the latency and bandwidth usage associated with communicating with cloud servers 470. Additionally or alternatively, network analysis component 426 can analyze availability of respective nodes in system 400, relative network loading, and/or other factors to facilitate intelligent selection of nodes from which to obtain information. Examples of network analysis that can be performed by network analysis component 428 are described in further detail infra. As an alternative example to employing a network analysis component 426 in connection with query component 420, a data index 422 stored at restoring peer 410 and/or one or more data indexes 454, 464, and/or 474 stored at various remote locations within system 400 can be preconfigured (e.g., by a network analyzer component 316 at a distribution component 310) to indicate an optimal location or set of locations from which to obtain respective information, such that index lookup component 424 can be given the ability to determine optimal locations from which to obtain information without requiring additional network analysis to be performed.

Upon identification of information to be obtained over network 400 by restoring peer 410 via query component 420, a data retrieval component 430 can obtain some or all of respective images (e.g. in VHD, VIM, and/or any other suitable format) associated with the rebuilding of restoring peer 410, and/or incremental portions thereof, from one or more respective data stores 452, 462, and/or 472 at peers 450, super peers 460, or cloud servers 470. Subsequently, an image and/or portions thereof obtained by data retrieval component 430 can be utilized by a system restore component 440 to restore the operating environment of restoring peer 410 to a desired state.

In one example, system restore component 440 can rebuild an operating environment associated with restoring peer 410 by merging one or more incremental images obtained from various locations within system 400 with some or all of the locally available operating system or environment of restoring peer 410. By way of specific, non-limiting example, a reverse difference algorithm (e.g., Remote Differential Compression (RDC)) can be utilized, wherein one or more noted differences between a locally available OS and/or other information and obtained images or image segments relating to a desired information version are subtracted from the locally available version of the information in order to roll back to the desired version. It should be appreciated, however, that such an algorithm is merely an example of a restoration technique that could be utilized, and that any other restoration algorithm could be used in addition to or in place of such an algorithm.

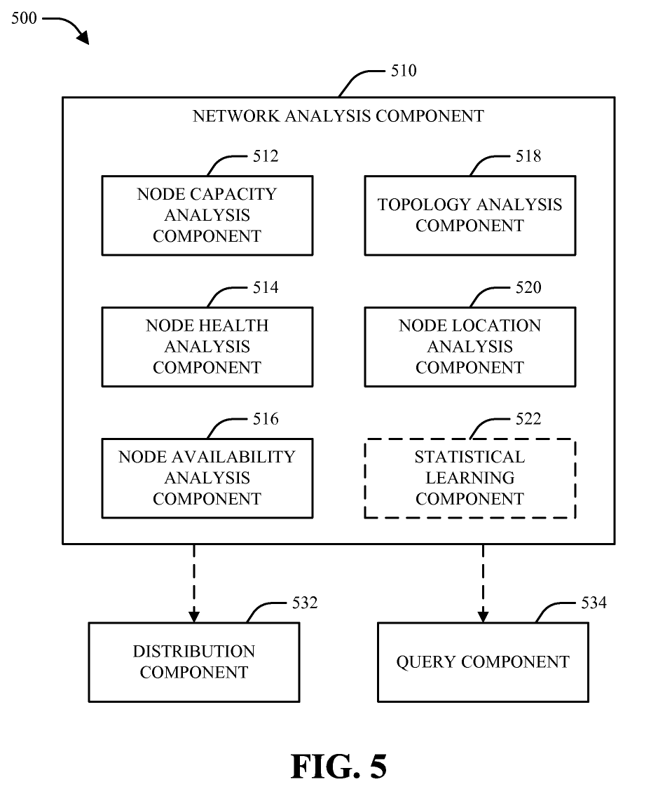

Turning now to FIG. 5, a block diagram of a system 500 that facilitates intelligent storage and retrieval of information within a distributed computing system in accordance with various aspects is illustrated. As system 500 illustrates, a network analysis component 510 can be employed to monitor one or more characteristics of a distributed network-based backup system associated with system 500. In one example, network analysis component 510 can be utilized in combination with a distribution component 532 in order to determine one or more optimal network nodes for distributing information, and/or with a query component 534 in order to determine one or more optimal network locations for retrieving previously distributed information. However, it should be appreciated that while system 500 illustrates both a distribution component 532 and a query component 534, a network analysis component 510 can be utilized in connection with either, both, or neither of such components.

In accordance with one aspect, network analysis component 510 can determine one or more optimal locations from which to distribute and/or retrieve information based on a variety of factors. For example, with respect to a given node location within a backup system, a node capacity analysis component 512 can be utilized to determine the storage capacity of a network node, a node health analysis component 514 can be utilized to assess the health of a network node (e.g., with respect to uptime, stability, average processor loading, etc.), and a node availability analysis component 516 can be utilized to assess the availability of a network node (e.g., with respect to powered-on or powered-off status, availability to service a particular request, etc.). In another example, a topology analysis component 518 can be utilized to assess the topology of an associated network (e.g. with respect to types of nodes within the network, such as peer nodes versus super-peer nodes) and any changes thereto (e.g., via addition or removal of devices, etc.). Additionally or alternatively, a node location analysis component 520 can be provided to select one or more network nodes for data distribution or retrieval based on proximity. For example, in the event that both a cloud server and a local peer are available, the node location analysis component 520 can apply a higher degree of preference to the local peer in order to reduce latency and conserve bandwidth. In another example, node location analysis component 520 can additionally or alternatively be utilized to determine the number of copies or replicas of the same information stored across the associated network. Thus, node location analysis component 520 can be utilized to maintain a tradeoff between reliability and/or speed for restore of data and the cost of storing data on a given set of peers.

As network analysis component 510 further illustrates, an optional statistical learning component 522 can additionally be employed to facilitate intelligent, automated selection of storage locations for respective information. In one example, statistical learning component 522 can utilize statistics-based learning and/or other suitable types of machine learning, artificial intelligence (AI), and/or other algorithm(s) generally known in the art. As used in this description, the term “intelligence” refers to the ability to reason or draw conclusions about, e.g., infer, the current or future state of a system based on existing information about the system. Artificial intelligence can be employed to identify a specific context or action, or generate a probability distribution of specific states of a system without human intervention. Artificial intelligence relies on applying advanced mathematical algorithms (e.g., decision trees, neural networks, regression analysis, cluster analysis, genetic algorithm, and reinforced learning) to a set of available data (information) on the system. For example, one or more of numerous methodologies can be employed for learning from data and then drawing inferences from the models so constructed, e.g. hidden Markov models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches (that perform data fusion, etc.) in accordance with implementing various automated aspects described herein.

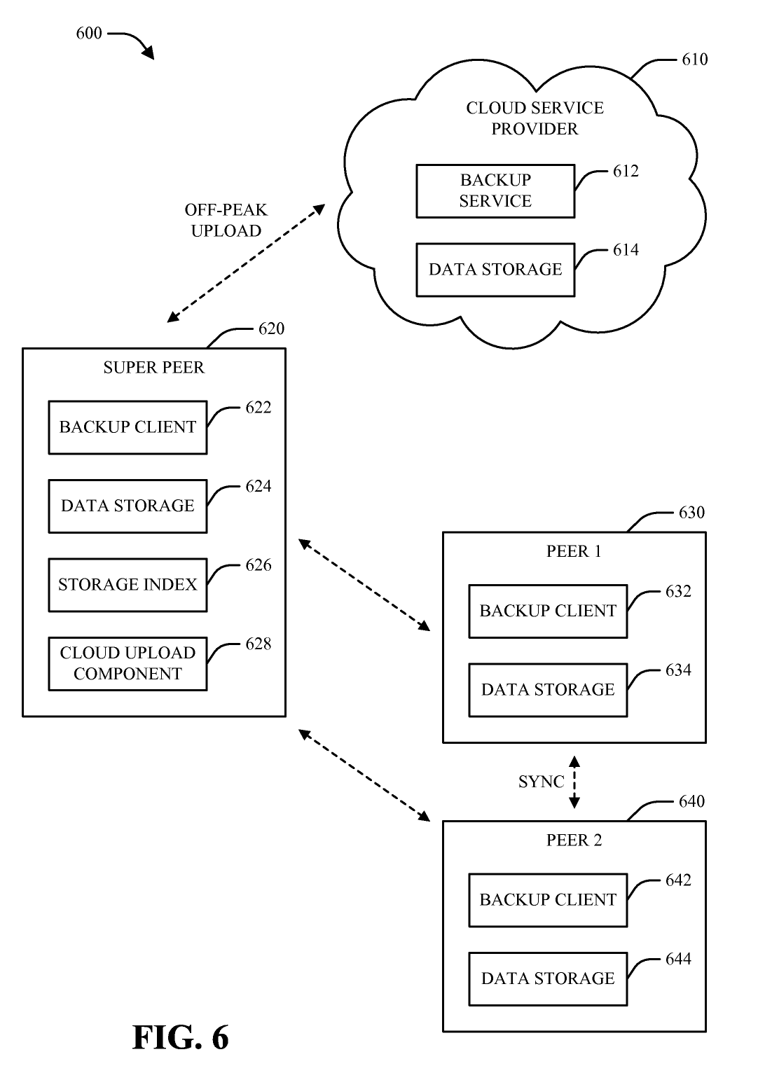

Referring next to FIG. 6, a diagram 600 is provided that illustrates an example network implementation that can be utilized in connection with various aspects described herein. As diagram 600 illustrates, a network implementation can utilize a hybrid peer-to-peer and cloud-based structure, wherein a cloud service provider 610 interacts with one or more super peers 620 and one or more peers 630-640.

In accordance with one aspect, cloud service provider 610 can be utilized to remotely implement one or more computing services from a given location on a network/internetwork associated with super peer(s) 620 and/or peer(s) 630-640 (e.g., the Internet). Cloud service provider 610 can originate from one location, or alternatively cloud service provider 610 can be implemented as a distributed Internet-based service provider. In one example, cloud service provider 610 can be utilized to provide backup functionality to one or more peers 620-640 associated with cloud service provider 610. Accordingly, cloud service provider 610 can implement a backup service 612 and/or provide associated data storage 614.

In one example, data storage 614 can interact with a backup client 622 at super peer 620 and/or backup clients 632 or 642 at respective peers 630 or 640 to serve as a central storage location for data residing at the respective peer entities 620-640. In this manner, cloud service provider 610, through data storage 614, can effectively serve as an online “safe-deposit box” for data located at peers 620-640. It can be appreciated that backup can be conducted for any suitable type(s) of information, such as files (e.g. documents, photos, audio, video, etc.), system information, or the like. Additionally or alternatively, distributed network storage can be implemented, such that super peer 620 and/or peers 630-640 are also configured to include respective data storage 624, 634, and/or 644 for backup data associated with one or more machines on the associated local network. In another example, techniques such as de-duplication, incremental storage, and/or other suitable techniques can be utilized to reduce the amount of storage space required by data storage 614, 624, 634, and/or 646 at one or more corresponding entities in the network represented by diagram 600 for implementing a cloud-based backup service.

In accordance with another aspect, cloud service provider 610 can interact with one or more peer machines 620, 630, and/or 640. As illustrated in diagram 600, one or more peers 620 can be designated as a super peer and can serve as a liaison between cloud service provider 610 and one or more other peers 630-640 in an associated local network. While not illustrated in FIG. 6, it should be appreciated that any suitable peer 630 and/or 640, as well as designated super peer(s) 620, can directly interact with cloud service provider 610 as deemed appropriate. Thus, it can be appreciated that cloud service provider 610, super peer(s) 620, and/or peers 630 or 640 can communicate with each other at any suitable time to synchronize files or other information between the respective entities illustrated by diagram 600.

In one example, super peer 620 can be a central entity on a network associated with peers 620-640, such as a content distribution network (CDN), an enterprise server, a home server, and/or any other suitable computing device(s) determined to have the capability for acting as a super peer in the manners described herein. In addition to standard peer functionality, super peer(s) 620 can be responsible for collecting, distributing, and/or indexing data among peers 620-640 in the local network. For example, super peer 620 can maintain a storage index 626, which can include the identities of respective files and/or file segments corresponding to peers 620-640 as well as pointer(s) to respective location(s) in the network and/or in cloud data storage 614 where the files or segments thereof can be found. Additionally or alternatively, super peer 620 can act as a gateway between other peers 630-640 and a cloud service provider 610 by, for example, uploading respective data to the cloud service provider 610 at designated off-peak periods via a cloud upload component 628. In another example, super peer 620 can serve as a cache for “hot” or “cold” data, such that the data that is most likely to be restored has a copy located closer to the restoring or originating peer and, over time, more copies are distributed to “colder” parts of the distributed system (e.g. data storage 614 at cloud service provider 610).

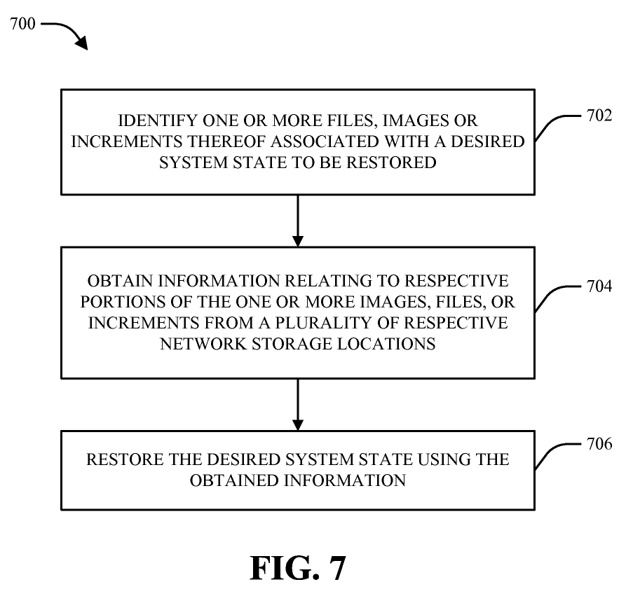

Turning to FIGS. 7-9, methodologies that may be implemented in accordance with various features presented herein are illustrated via respective series of acts. It is to be appreciated that the methodologies claimed herein are not limited by the order of acts, as some acts may occur in different orders, or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as claimed herein.

Referring to FIG. 7, a method 700 for restoring a system using a distributed backup network is illustrated. At 702, one or more files, images, or increments thereof associated with a desired system state to be restored are identified (e.g., by a query component 112). At 704, information relating to respective portions of the one or more images, files, or increments identified at 702 is obtained (e.g. by a data retrieval component 114) from a plurality of respective network storage locations (e.g., network storage locations 120). At 706, the desired system state is restored (e.g., by a system restore component 116) using the information obtained at 704.

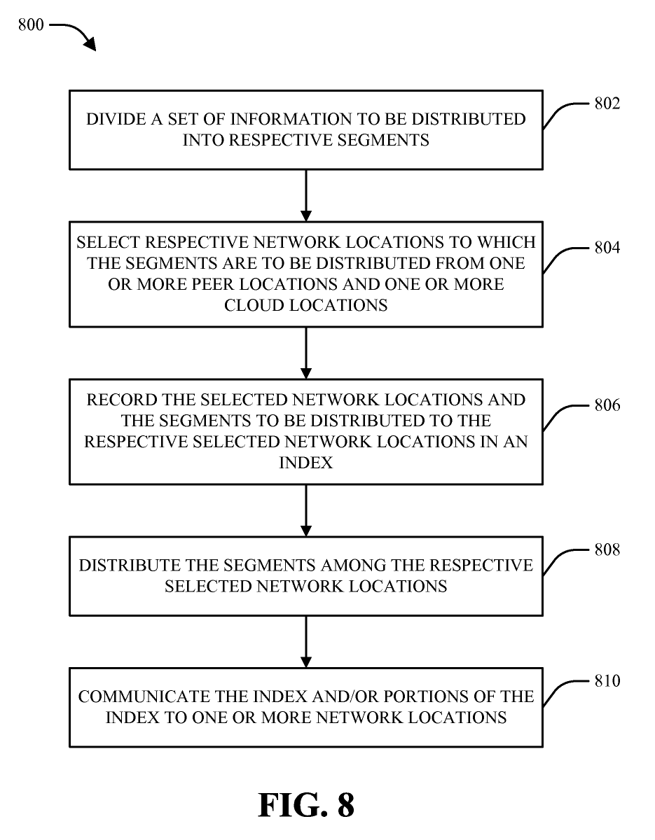

Referring now to FIG. 8, a flowchart of a method 800 for distributing data to respective locations in a network-based backup system is provided. At 802, a set of information to be distributed is divided into respective segments (e.g., by a segmentation component 214). At 804, respective network locations to which the segments created at 802 are to be distributed are selected (e.g., by a distribution component 310) from one or more peer locations (e.g., peers 320 and/or super-peers 330) and one or more cloud locations (e.g., cloud storage 340). At 806, the network locations selected at 804 and the segments to be distributed to the selected network segments are recorded in an index (e.g., by an indexing component 312). At 808, the segments created at 802 are distributed among the network locations selected at 804. In one example, the segments created at 802 can be stored across the distributed system multiple times and at different locations. Additionally or alternatively, if respective segments already exist at given locations, they can be single-instanced. Finally, at 810, the index created at 806 and/or portions of the index (e.g., as divided by an index division component 314) are communicated to one or more network locations (e.g., locations 320-340).

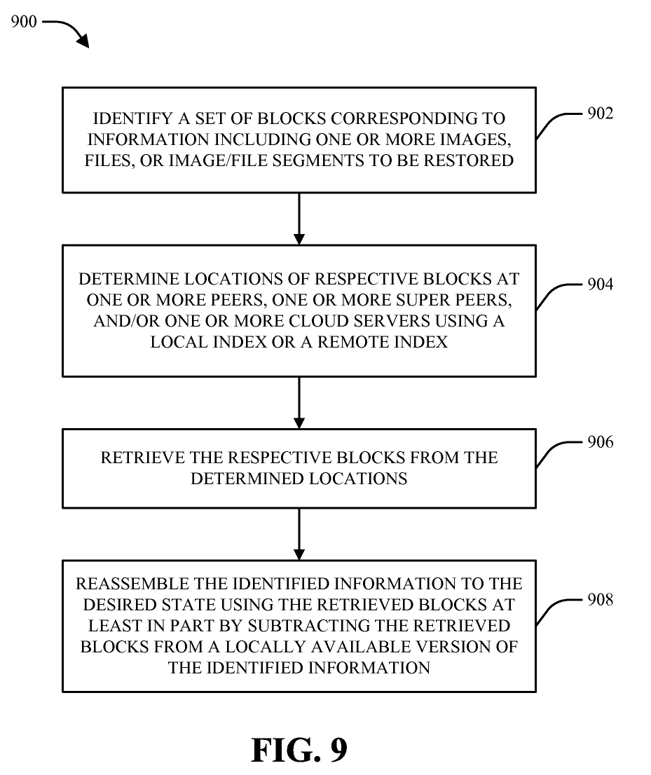

FIG. 9 illustrates a method 900 for identifying, retrieving, and restoring data in a network-based backup environment. At 902, a set of blocks corresponding to information including one or more images, files, or image/file segments to be restored are identified (e.g., by a query component 420). At 904, locations of respective blocks identified at 902 at one or more peers (e.g., peers 450), one or more super peers (e.g., super peer 460), and/or one or more cloud servers (e.g., cloud server(s) 470) are determined (e.g., by an index lookup component 424) using a local index (e.g., data index 422) or a remote index (e.g., data indexes 454, 464, and/or 474). At 906, the blocks identified at 902 are retrieved (e.g., by a data retrieval component 430) from the locations determined at 904. At 908, the information identified at 902 is restored (e.g. via a system restore component 440) using the blocks retrieved at 906 at least in part by subtracting the retrieved blocks from a locally available version of the information identified at 902.

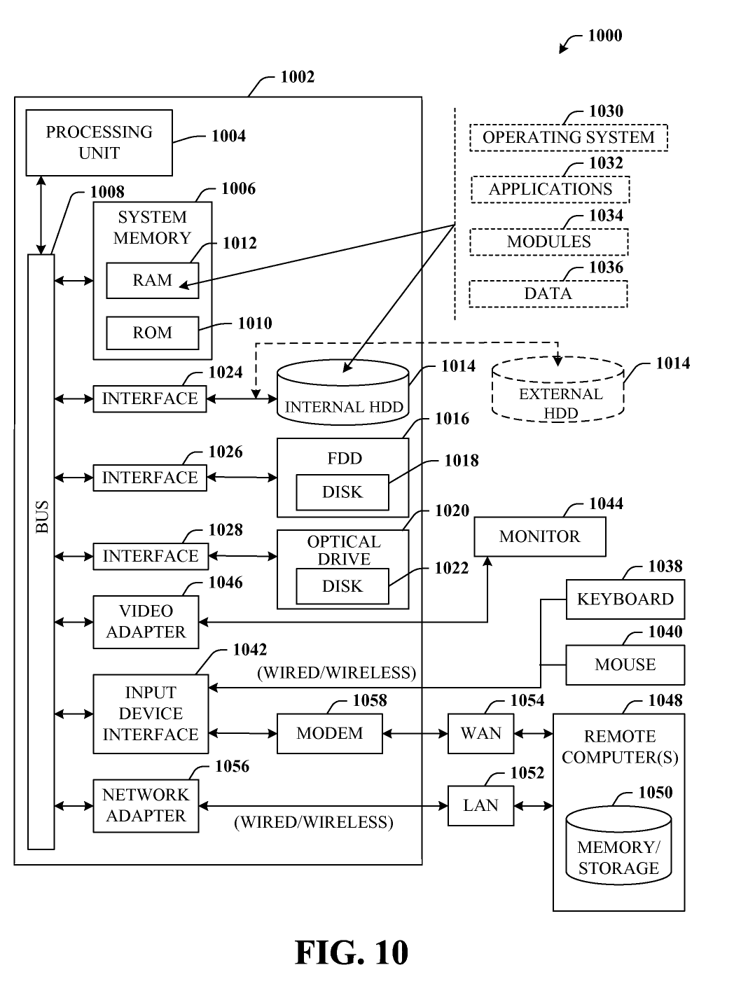

In order to provide additional context for various aspects described herein, FIG. 10 and the following discussion are intended to provide a brief, general description of a suitable computing environment 1000 in which various aspects of the claimed subject matter can be implemented. Additionally, while the above features have been described above in the general context of computer-executable instructions that may run on one or more computers, those skilled in the art will recognize that said features can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the claimed subject matter can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, an exemplary environment 1000 for implementing various aspects described herein includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE-1394 interface technologies. Other external drive connection technologies are within contemplation of the subject disclosure.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, a serial port, an IEEE-1394 port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 13 Mbps (802.11a) or 54 Mbps (802.11b) data rate, for example, or with products that contain both bands (dual band). Thus, networks using Wi-Fi wireless technology can provide real-world performance similar to a 10BaseT wired Ethernet network.

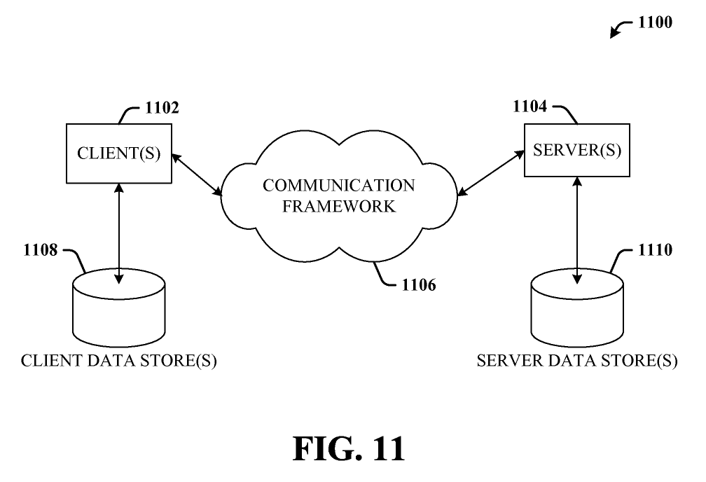

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g. threads, processes, computing devices). In one example, the client(s) 1102 can house cookie(s) and/or associated contextual information by employing one or more features described herein.

The system 1100 also includes one or more server(s) 1104. The server(s) 1104 can also be hardware and/or software (e.g., threads, processes, computing devices). In one example, the servers 1104 can house threads to perform transformations by employing one or more features described herein. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g. a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the described aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for restoring information from a backup system, comprising:
a processor that executes machine-executable components stored on a computer-readable medium, the components comprising:
a query component that identifies information to be restored that is associated with a desired state of an associated computing device and a plurality of storage locations on a network at which respective portions of the information are located, wherein the information comprises at least a portion of a file or a system image;
a data retrieval component that obtains the respective portions of the information from the identified plurality of storage locations; and
a system restore component that restores the computing device to the desired state using the obtained information.

2. The system of claim 1, wherein the plurality of storage locations comprise at least one peer device and at least one cloud server.

3. The system of claim 1, further comprising:
an imaging component that collects system image information from the computing device; and
a distribution component that distributes the system image information to respective storage locations on the network.

4. The system of claim 3, wherein the system image information comprises one or more of an image of an operating system associated with the computing device or a system snapshot obtained from the computing device.

5. The system of claim 1, wherein the information to be restored comprises one or more delta images that include information relating to changes between a current operating state of the computing device and one or more previous operating states of the computing device.

6. The system of claim 1, further comprising a segmentation component that divides information corresponding to files or system images into respective blocks, wherein the distribution component distributes the respective blocks to respective storage locations on the network.

7. The system of claim 6, wherein the distribution component distributes the respective blocks to respective storage locations on the network based at least in part on amounts of copies of respective blocks that exist at the respective storage locations.

8. The system of claim 1, wherein the query component further comprises an index lookup component that identifies the plurality of storage locations at which the respective portions of the information to be restored are located based on one or more indexes that map respective data stored in the network to locations at which the respective data are stored.

9. The system of claim 8, wherein at least one index utilized by the index lookup component is stored at one or more of the computing device or a remote storage location in the network.

10. The system of claim 1, further comprising a boot component that facilitates booting the computing device and identifying the information to be restored from at least one remote location in the network.

11. The system of claim 1, wherein the system restore component restores the computing device to the desired state by merging obtained information to be restored with information locally stored at the computing device.

12. The system of claim 1, wherein the query component further comprises a network analysis component that determines storage locations on the network from which the respective portions of the information to be restored are to be retrieved based on one or more of locality of respective storage locations, health of respective storage locations, network topology, peer machine type, or availability of respective storage locations.

13. A method of performing system recovery within a network-based backup system, comprising:
identifying data associated with a desired system state to be restored comprising one or more files, images, or file or image segments;
obtaining information relating to respective portions of the data associated with the desired system state to be restored from a plurality of respective network storage locations; and
restoring the desired system state at one or more computer memories associated with the desired system state using the obtained information.

14. The method of claim 13, wherein the obtaining comprises:
identifying a set of blocks corresponding to the data associated with the desired system state to be restored;
determining respective peer storage locations or cloud storage locations from which respective identified blocks are to be retrieved; and
retrieving the identified blocks from the respectively determined peer storage locations or cloud storage locations.

15. The method of claim 14, wherein the determining comprises determining respective peer storage locations or cloud storage locations from which respective identified blocks are to be retrieved using at least one of a locally stored index or a remotely stored index.

16. The method of claim 14, wherein the determining comprises determining respective peer storage locations or cloud storage locations from which respective identified blocks are to be retrieved based on one or more of locality of respective network storage locations, health of respective network storage locations, network topology, peer machine type, or availability of respective network storage locations.

17. The method of claim 13, further comprising:
dividing information associated with a current system state into respective segments;
selecting respective network storage locations to which the segments are to be distributed from one or more peer locations and one or more cloud locations; and
distributing the segments among the respective selected network storage locations.

18. The method of claim 17, further comprising:
recording the selected network locations and the respective segments to be distributed thereto in an index; and
communicating at least a portion of the index to one or more network storage locations.

19. The method of claim 13, further comprising initiating a network boot from at least one remote location in the network, wherein the identifying data associated with the desired system state to be restored comprises identifying the data associated with the desired system state to be restored using the remote location to which the network boot was initiated.

20. A machine-readable medium having stored thereon instructions which, when executed by a machine, cause the machine to act as a system for performing system recovery from a distributed backup system, the system comprising:
means for distributing at least a portion of a file or a system image among one or more peers and one or more cloud storage locations based on at least one of locality, capacity, health, or types of respective storage locations;
means for identifying initialization of a system restore;
means for querying at least one peer or at least one cloud storage location for copies of at least a portion of the file or the system image upon initialization of the system restore;
means for determining a plurality of optimal locations from which to obtain at least a portion of the file or the system image based on received query results; and
means for rebuilding an associated system at least in part by retrieving information corresponding to at least a portion of the file or the system image from the determined optimal locations.
